(19) United States
(12) Patent Application Publication
(10) Pub. No.: US 2022/0156067 A1
(43) Pub. Date: May 19, 2022

(54) BLOCKCHAIN MICROPROCESSOR AND METHOD

(71) Applicant: CARBON-BLOCK INC., Winnipeg, Manitoba (CA)

(72) Inventor: Alex STUART, Winnipeg, Manitoba (CA)

(21) Appl. No.: 17/626,111

(22) PCT Filed: Jul. 10, 2020
(86) PCT No.: PCT/CA2020/050961

§ 371 Date: Jan. 10, 2022

(51) Int. Cl. G06F 9/30; G06F 13/36; G06F 12/0875

(52) U.S. Cl. CPC G06F 9/3001; G06F 2212/452; G06F 12/0875; G06F 13/36

(57) ABSTRACT

A blockchain microprocessor core for a blockchain having a primary memory with instructions stored therein. A control processor and/or an arithmetic-logic processor executes at least one of the instructions. The core may also have one or more registers, a blockchain general ledger; a blockchain memory; and at least one input/output (IO) port. An initiation protocol may establish a data stream over the at least one IO port; verify the data stream over the at least one IO port; and establish at least one data transfer protocol between the control processor and a receiving device via the at least one IO port.

### CROSS-REFERENCE IO RELATED APPLICATIONS

This application claims priority to U.S. Prov. App. No. 62/872,914, filed on Jul. 11, 2019, the contents of which are explicitly incorporated by reference herein in its entirety.

### TECHNICAL FIELD

This disclosure relates to methods and devices of blockchain technology, and more specifically to blockchain microprocessors and methods for data storage, transfer and sharing between devices.

### BACKGROUND

The current use of Block chain technology focuses mainly on the use of the general ledger to record ownership of non-fungible tokens mainly used to document financial transactions along with the derivative products, including, but not limited to loans, interest payments, collateral, debt obligations, and in some cases real-world assets including medical history, personal identification data, physical art, music, or real estate.

Blockchain technology can be defined as a record of data and data transactions between two or more unrelated parties typically referred to as a general ledger. Typically, all participants in the blockchain have identical copies of the general ledger. Another defining feature of the blockchain is the consensus protocol used to verify the validity and integrity of the data being written to the general ledger.

### SUMMARY

Any and all aspects as described herein, individually and/or in any combination consistent to the understanding of one of skill in the art upon review of the present application.

According to an aspect herein, there is provided a blockchain microprocessor core for a blockchain. The blockchain microprocessor core may have a primary memory for storing one or more instructions therein; a control processor may execute one or more of the instructions; an arithmetic-logic processor may execute one or more of the instructions. The blockchain microprocessor core may have one or more registers; a blockchain general ledger; a blockchain memory; and one or more input/output (IO) ports. The registers may have a blockchain instruction register, a blockchain address register, a blockchain buffer register, and a blockchain program counter.

The instructions may have an initiation protocol. The initiation protocol may: establish a data stream over the at least one IO port; verify the data stream over the at least one IO port; and establish one or more data transfer protocols between the control processor and a receiving device via the at least one IO port. The receiving device may be selected from one or more of: another blockchain microprocessor core, a server, a blockchain validator, an Internet Protocol address, a MAC address, a DNS address, a blockchain miner, a blockchain node, a data router, an Internet-of-Things device, and a blockchain-of-things device. The data transfer protocols may establish a security protocol, a routing table, and a consensus protocol. The consensus protocol may have one or more of a proof-of-work and a proof-of-stake.

The instructions may determine one or more node parameters for a secure functioning and validation of the blockchain. The node parameters may be selected from one or more of: a speed of block verification, a duration for the blockchain, and an availability of computing power within an accessible sphere of influence.

According to another aspect, there is provided a processor for a blockchain. The processor may have a plurality of blockchain microprocessor cores; a bus interface; at least one L1 blockchain cache associated with each of the plurality of blockchain microprocessor cores; at least one L2 cache shared between the plurality of blockchain microprocessor cores. The processor may have a blockchain memory storing a plurality of instructions. The blockchain memory may have one or more of: a blockchain random access memory (B-RAM), a blockchain read-only memory (B-ROM), a blockchain basic input output system (B-BIOS), and a blockchain general ledger. The one or more blockchain microprocessor cores may execute a heartbeat protocol for the blockchain.

The B-BIOS may have the instructions to perform a boot cycle comprising at least one reference instruction, a data, and a logic received from the blockchain. The B-BIOS may have the instructions to establish a connection to the blockchain. The B-BIOS may have the instructions to manage at least one data flow between the plurality of blockchain processor cores and the blockchain. The B-BIOS may fetch the instructions from the B-ROM.

The processor may further have one or more general central processing unit cores in communication with the plurality of blockchain microprocessor cores over the bus interface.

### BRIEF DESCRIPTION OF THE FIGURES

While the disclosure is claimed in the concluding portions hereof, example embodiments are provided in the accompanying detailed description which may be best understood in conjunction with the accompanying diagrams, and where:

FIG. 1 is a block diagram of a blockchain microprocessor;

FIG. 2 is a block diagram of another blockchain microprocessor;

FIG. 3 a block diagram of a blockchain microprocessor according to a further aspect; and

FIG. 4 is a block diagram of a blockchain microprocessor according to another aspect.

### DETAILED DESCRIPTION

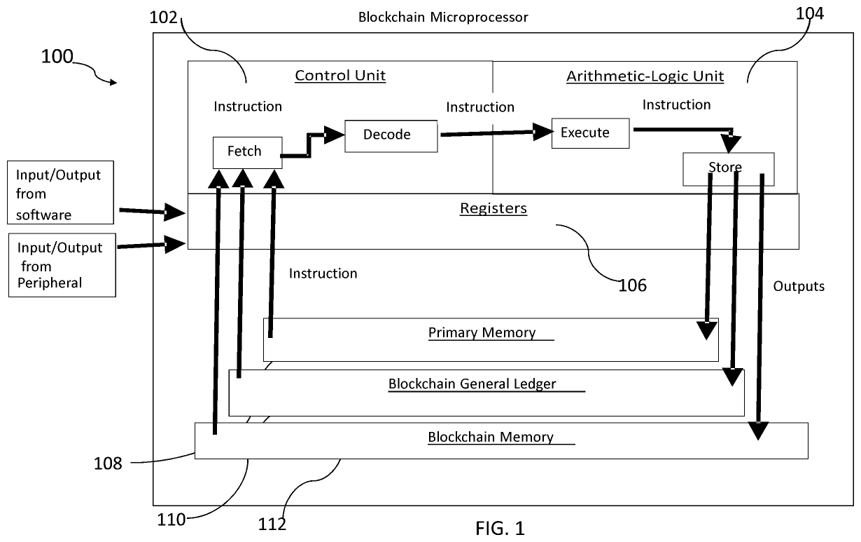

Blockchain technology is designed by nature to be trustless, meaning little to no trust may be required between participants for a blockchain to function as intended. Every increase in distance between an electrical signal and the blockchain requires trust in an automatic or manual process. As shown in FIG. 1, a blockchain microprocessor 100 according to one aspect described herein provides a shortest distance between the electrical signal and a circuit or device capable of writing, and/or reading, data to, and/or from, the blockchain directly or through an intermediary.

Previously, blockchain technology refers to the blockchain used as a means of storing information or data, known as a general ledger, or a means of executing pieces of computer code, known as a smart contract. The blockchain as described herein may provide a means of data communication (e.g. transmission and reception) between one or more independent electronic units, such as, for example, separate portions of a circuit board, separate computing machines, or separate blockchains. The blockchain technology described herein may enable a form of computer programming in which the data communication occurs via the blockchain.

Another aspect described herein applies the blockchain technology to a data transfer between one or more computing devices, specifically by providing a dedicated, purpose-built microprocessor 100. This microprocessor 100 may either soldered into the circuit board, inserted onto the circuit board as a peripheral, or may function as a standalone computing device with a dedicated circuit board, and is wired such that the microprocessor 100 receives at least the same inputs, if not more, as a main processor or other data stream as applicable. The microprocessor 100 may also receive data from the main processor but may operate without control from the main processor and/or any other portion of the circuit board other than power from a power supply. The blockchain microprocessor 100 may also send control signals to the main processor and/or any other portion of the circuit board.

Using the blockchain for data transfer between the one or more circuits and/or computing devices enables these devices to conduct one or more operations in a shared environment similar to a shared “reality”. This shared reality may be analogous to living organisms sharing a reality through sensory inputs of sight, touch, smell, taste, and so on. Prior computing devices were typically provided with a permissioned reality in which to operate. These permissioned realities constrain the input sources of the computing devices, which may be limited by space, sensor data, time, and/or permission to access centralized databases and/or memory. The shared reality may be a useful function of the general ledger as created by blockchain technology since the shared reality provides access to all computing devices sharing the blockchain to have a more complete permission to data, and may interact better with, the physical or digital environment without constraint while equally prohibiting unauthorized modification.

An example of blockchain technology applications is to determine or track carbon emission, such as those disclosed in U.S. Provisional Application Ser. No. 62/726, 859, entitled: “System And Method For Incorporating Sensor Measurements Into A Blockchain”, filed on Sep. 4, 2018, the disclosure of which is incorporated by reference.

With reference to FIG. 1, a blockchain microprocessor 100 may be provided comprising a control unit 102, an arithmetic-logic unit 104, and/or registers 106. The microprocessor 100 may also have a primary memory 108, a blockchain general ledger 110, and/or a blockchain memory 112. The registers 106 may include dedicated specialized registers, such as i) Blockchain Instruction Register, ii) Blockchain address Register, iii) Blockchain Buffer Register and/or iv) Blockchain Program Counter.

The general functions provided by the blockchain microprocessor 100 may include a number of functions as described herein. During initialization of the microprocessor 100, an initialization function may engage in an initiation protocol where the protocol has three distinct functions: (1) Establishing and verifying an incoming data stream from the circuit board; (2) Establishing one or more data transfer protocols between the microprocessor 100 and the other aspects of the circuit board, and (3) Establishing the data transfer protocol between the microprocessor 100 and a receiving device. This receiving device may be another blockchain microprocessor device 100, a server, a blockchain validator, an Internet Protocol address, a MAC address, a DNS address, a blockchain miner, a blockchain node, a data router, and/or any other Internet-of-Things device and/or blockchain-of-things device with the capacity to receive, process, and send data.

The outward-facing data transfer protocol establishment (e.g. handshake) may enable the microprocessor 100 to establish combinations of one or more data transfer protocols that may be used for the data transfer. The protocol establishment may specify any security protocols required, routing tables for a specific route the data transfer may take between the one or more devices, and one or more details of the establishment, structuring, transferring, securing, and/or termination of the blockchain data. The handshake may also establish which consensus protocol the blockchain microprocessors 100 may use, including but not limited to, proof-of-work or proof-of-stake. This outward facing data transfer protocol establishment may be broadcast by one or all of the following: Wi-Fi signal, Peer-to-peer communication, Blockchain communications protocol, sound frequencies (auditory and/or ultrasonic), Microwave frequencies, Power Line communications, TCP/IP, and/or any other communications protocol or technique.

One or more functions of the blockchain microprocessor 100 may include control of the blockchain microprocessor 100, read/write, and communications functions of the circuit board. The blockchain microprocessor 100 can also serve as either a slave, a master, or an equal to the main processor or any other function of the circuit board or machine. The blockchain microprocessor 100 may send and receive instructions to and/or from third parties' devices, peripherals, and/or inter-machine functions. The blockchain microprocessor 100 may use shared, or dedicated resources, within the computing machine and circuit board including short- and long-term memories (e.g. random access memory (RAM), read-only memory (ROM), hard disk, Flash memory, etc.).

Multiple blockchain microprocessors 100 on the same circuit board and/or between separate circuit boards or computing devices may share resources and/or coordinate operations. One such example may be in swarm-type computing devices where the blockchain microprocessor 100 may coordinate cooperation and sharing of resources within the swarm. The swarm may dedicate a portion of the computing resources to an operation of an individual circuit board and dedicate another portion of the circuit board's resources to the shared goal of the successful operation of the blockchain. The allocation of resources may be static or dynamically performed (either asynchronously or synchronously).

The blockchain microprocessor 100 may transmit data including, but not limited to logic, algorithms, and/or mathematical operations, from one blockchain microprocessor to another blockchain processor independent of a source.

The blockchain microprocessor 100 may be programmed with firmware at a time of manufacture and may be capable of incorporating algorithms from other blockchain processors 100. The blockchain microprocessor 100 may design algorithms as an evolution of operations and/or from sharing at least a portion of an algorithm from other blockchain microprocessors. The blockchain microprocessor 100 may also obtain one or more algorithms from any other sources of data.

The blockchain microprocessor 100 may determine which data is stored in, and retrieved from, short-term and long-term memory. The data storage memory may be physically located adjacent to (or within) the blockchain microprocessor 100 on a circuit board. The data storage memory may be located remotely such as in the cloud, or on a separate computing device which is in blockchain communication with the microprocessor 100, or in a purpose built blockchain data center on the circuit board. By storing blockchain data in a purpose build memory data center, the resources of the other processors on the circuit board may be freed from having to maintain the integrity of the blockchain and permit the other processors to perform the other functions of the circuit board.

The logic of the microprocessor 100 may determine content of a genesis block of the blockchain along with any other aspects of the blockchain's nature and operation.

The blockchain microprocessor 100 may dedicate and/or coordinate computing power from the blockchain microprocessor 100, the main processor, and/or any other aspect of the circuit board, to a hash rate and/or operations to maintain proper operation of the blockchain.

The blockchain microprocessor 100 may fetch commands from the blockchain in addition to memory and registry sources located on the circuit board. The blockchain processor may execute logic from data contained on the blockchain.

The blockchain microprocessor 100 may determine a size and a number of one or more nodes required in a network for a secure functioning and validation of the blockchain and may make connections with those other validators. The size and the number may be determined by parameters including but not limited to a speed of block verification, a duration the blockchain is expected to be used for, an availability of spare computing power within a sphere of influence to which the blockchain microprocessor has access.

The blockchain microprocessor 100 may establish one or more necessary parameters, and may perform one or more necessary steps, for a consensus protocol to be used in the blockchain.

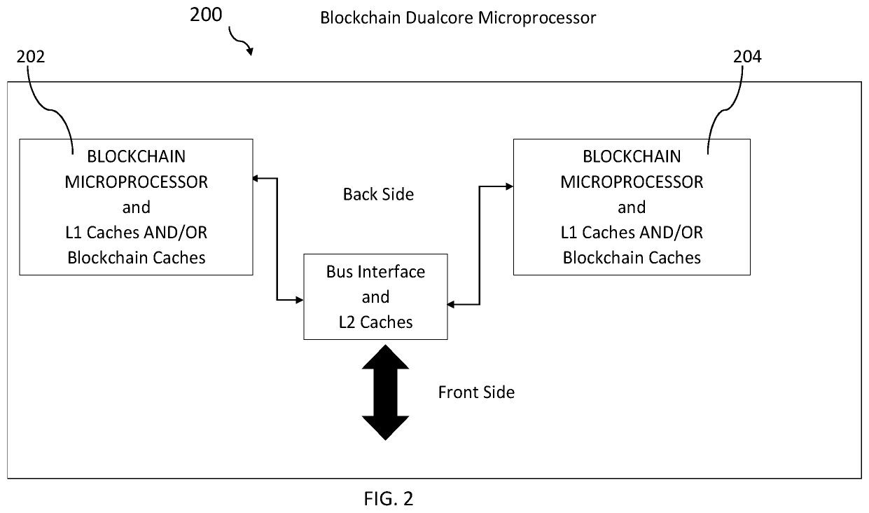

According to one aspect, the blockchain microprocessor 100 may be constructed with additional blockchain microprocessors 100 in order to have a dual-core blockchain microprocessor. For example, FIG. 2 illustrates a dual-core blockchain microprocessor 200 having a first sub-blockchain microprocessor 202 and a second sub-blockchain microprocessor 204.

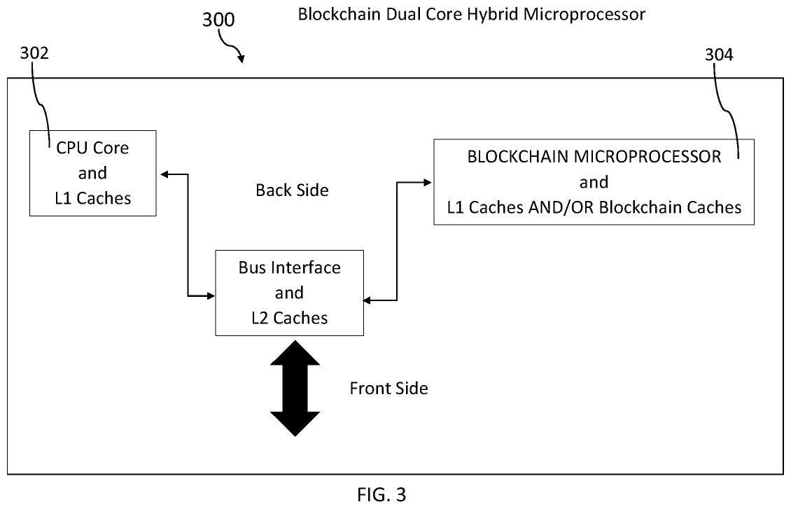

According to another aspect, the blockchain microprocessor 100 may be a dual-core hybrid microprocessor 300 having a general-purpose CPU core 302 and a blockchain microprocessor 100. FIG. 3 illustrates a blockchain microprocessor 300 having a CPU core 302 and a sub-blockchain microprocessor 304.

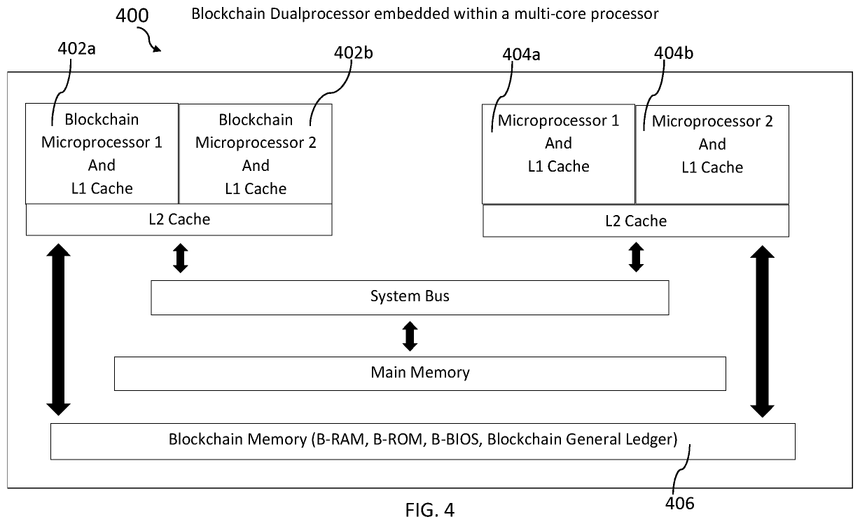

According to further aspect, the blockchain processer 100 may comprise dual-processors embedded within a multi-core processor. As shown in FIG. 4, the blockchain processer 400 includes a dual blockchain microprocessor having a sub-blockchain microprocessor 402a and a sub-blockchain microprocessor 402b, and dual-core general-purpose processor including microprocessor 404a and microprocessor 404b.

The blockchain microprocessor 100 may include a dedicated RAM and/or a dedicated ROM having capacities independent of a system RAM and a system ROM. For example, the blockchain microprocessor 400 may have Blockchain RAM (B-RAM) and Blockchain ROM (B-ROM) 406. The B-RAM may be used to store incoming data and/or logic from the blockchain and the B-ROM may be used to store data and/or logic on a more permanent basis (e.g. after power has been removed from the processor). The blockchain microprocessor 100 may have authority over the B-RAM and the B-ROM. ROM is used herein to not exclusively be read-only but may be modified. The intended use of ROM herein is to imply that the data and/or instructions stored therein are maintained once power has been removed.

According to a further aspect, a blockchain microprocessor 100 may also comprise a Blockchain Basic Input Output System (B-BIOS), as shown in FIG. 4. The B-BIOS may have the instructions referenced during a boot cycle to reference instructions, data, or logic, received from the blockchain, or to establish the connection to the blockchain upon circuit boot up. The B-BIOS may manage one or more data flows between the device and the blockchain and/or any peripherals that may be connected to the device. The B-BIOS tests system hardware on the computing device on startup. The B-BIOS may then fetch any instructions in the B-ROM called the Blockchain Boot Sector (B-BOOT). This B-BOOT sector program may execute instructions that help to utilize the computing device effectively and/or enable the blockchain functionality to operate properly.

In blockchain communications, a problem may be encountered known as “split-brain” problem. The split-brain problem refers to data or availability inconsistencies resulting from maintenance and operation of two or more separate data sets or communication protocols (e.g. DNS) that overlap in scope. The split-brain problem occurs when the data sets do not communicate and synchronize properly. The split-brain problem may cause data corruption, and/or data loss, as the newly split portions of the communications protocols, and/or data sets, both claim each are correct and continue to function independently of each other.

A solution to the split-brain problem may be an agreed upon heartbeat protocol, which functions to synchronize the two or more sides of the data, and/or communications streams. The heartbeat protocol operates on a First-in First-out basis to handle the data streams throughout the network. As part of the heartbeat protocol the respective nodes may send a response indicating the node remains active and continues to function in a coordinated manner.

According to one aspect, the blockchain microprocessor 100 may operate the heartbeat protocol to provide other computing devices an indication that the blockchain microprocessor 100 is operational. The heartbeat protocol may be synchronized and maintained by the blockchain microprocessor 100. The blockchain microprocessor 100 may ensure sufficient numbers of network links that serve as additional heartbeat channels to the CPU in order to prevent this split-brain problem. The blockchain microprocessor 100 may be used for automation of a quorum-consensus approach to resolve any conflict between one or more nodes.

According to another aspect, the blockchain microprocessor 100 may be manufactured as a standalone microprocessor on a circuit board, or as part of a multi-core processor, such as the multi-core processor 400 shown in FIG. 4. Multi-core processors are also intended to refer to digital signal processors (DSP) and system on a chip (SoC). Where parallel operations is intended to refer to systems that run in parallel to a blockchain operation, use the read/write functions of the blockchain, or run as a program that uses both the blockchain and one or more microprocessors as shown in FIG. 4.

In another aspect, the blockchain microprocessor may be designed as a OSI-compatible device as per the following ISO standards; ISO/IEC 7498-1 The Basic Model, ISO 7498-2 Security Architecture, ISO/IEC 7498-3 Naming and addressing, and ISO/IEC 7498-4 Management framework, or any other standard or programming language used in signal processing, and networking protocols.

In some aspects, the blockchain microprocessor 100 may operate with a shared cache alongside other microprocessors, or be designed with a dedicated cache, including but not limited to a blockchain-BIOS which may be designed as electrically-erasable programmable ROM chip, a blockchain-RAM and a blockchain ROM. These may be considered additional registers on the chip.

The foregoing is considered as illustrative only of the principles of the disclosure. Further, since numerous changes and modifications will readily occur to those skilled in the art, it is not desired to limit the disclosure to the exact construction and operation shown and described, and accordingly, all such suitable changes or modifications in structure or operation which may be resorted to are intended to fall within the scope of the claimed disclosure.

1. A blockchain microprocessor core for a blockchain comprising:
a primary memory with instructions stored therein;
a control processor executing at least one of the instructions;
an arithmetic-logic processor executing at least one of the instructions;
at least one register;
a blockchain general ledger;
a blockchain memory; and
at least one input/output (IO) port.

2. The blockchain microprocessor core of claim 1, wherein the at least one register comprises at least one of: a blockchain instruction register, a blockchain address register, a blockchain buffer register, and a blockchain program counter.

3. The blockchain microprocessor core of claim 1, wherein the instructions comprise an initiation protocol.

4. The blockchain microprocessor core of claim 1, wherein the initiation protocol comprises: establishing a data stream over the at least one IO port; verifying the data stream over the at least one IO port; and establishing at least one data transfer protocol between the control processor and a receiving device via the at least one IO port.

5. The blockchain microprocessor core of claim 4, wherein the receiving device is selected from at least one of: another blockchain microprocessor core, a server, a blockchain validator, an Internet Protocol address, a MAC address, a DNS address, a blockchain miner, a blockchain node, a data router, an Internet-of-Things device, and a blockchain-of-things device.

6. The blockchain microprocessor core of claim 4, wherein the at least one data transfer protocol comprises: establishing a security protocol, a routing table, and a consensus protocol.

7. The blockchain microprocessor core of claim 6, wherein the consensus protocol comprises at least one of: a proof-of-work and a proof-of-stake.

8. The blockchain microprocessor core of claim 1, wherein the instructions comprise: determining at least one node parameter for a secure functioning and validation of the blockchain.

9. The blockchain microprocessor core of claim 8, wherein the at least one node parameter is selected from at least one of: a speed of block verification, a duration for the blockchain, and an availability of computing power within an accessible sphere of influence.

10. A processor for a blockchain comprising:
a plurality of blockchain microprocessor cores;
a bus interface;
at least one L1 blockchain cache associated with each of the plurality of blockchain microprocessor cores;
at least one L2 cache shared between the plurality of blockchain microprocessor cores.

11. The processor of claim 10, further comprising at least one general central processing unit (CPU) core in communication with the plurality of blockchain microprocessor cores over the bus interface.

12. The processor of claim 11, further comprising a blockchain memory storing a plurality of instructions.

13. The processor of claim 12, wherein the blockchain memory comprises at least one of: a blockchain random access memory (B-RAM), a blockchain read-only memory (B-ROM), a blockchain basic input output system (B-BIOS), and a blockchain general ledger.

14. The processor of claim 13, wherein the B-BIOS comprises the instructions to perform a boot cycle comprising at least one reference instruction, a data, and a logic received from the blockchain.

15. The processor of claim 13, wherein the B-BIOS comprises the instructions to establish a connection to the blockchain.

16. The processor of claim 13, wherein the B-BIOS comprises the instructions to manage at least one data flow between the plurality of blockchain processor cores and the blockchain.

17. The processor of claim 13, wherein the B-BIOS fetches the instructions from the B-ROM.

18. The processor of claim 10, wherein the at least one blockchain microprocessor core executes a heartbeat protocol for the blockchain.
